(19) United States
(12) Patent Application Publication
(10) Pub. No.: US 2026/0224071 A1
(43) Pub. Date: Aug. 6, 2026

(54) BLENDER SYSTEM LOCKING MECHANISMS AND SWITCH ASSEMBLIES

(71) Applicant: VITA-MIX MANAGEMENT CORPORATION, Olmsted Township, OH (US)

(72) Inventors: Brad Paskert, Strongsville, OH (US); William Kickel, North Olmsted, OH (US); Michael Leighton Fry, Bay Village, OH (US)

(73) Assignee: VITA-MIX MANAGEMENT CORPORATION, Olmsted Township, OH (US)

(21) Appl. No.: 19/398,192

(22) Filed: Nov. 24, 2025

Related U.S. Application Data
(60) Provisional application No. 63/727,704, filed on Dec. 4, 2024.

(51) Int. Cl. A47J 43/07; A47J 43/046; A47J 43/08

(52) U.S. Cl. CPC A47J 43/0766; A47J 43/046; A47J 43/085

(57) ABSTRACT

A blender system is shown and described. A blender system may include a blender base that includes an electric motor and a power source including a switch where the power source is electrically coupled to the electric motor and operation of the switch inhibits power from delivering from the power source to the electric motor. The blender base may also include a blender base body, that includes side walls that define an inner surface with upper protrusions forming an upper ledge and lower protrusions forming a lower ledge on the side walls, and switch assemblies that include actuators that are movable between a raised and lowered position. The blender system may also include a container, where engageable with the upper protrusions of the blender base body, and a blade base engageable with the lower protrusions of the blender base, where the blade base includes a blade engageable with the motor.

### CROSS-REFERENCE TO RELATED APPLICATION

This application claims the benefit of co-pending U.S. Provisional Patent Application No. 63/727,704, filed December 4, 2024, for “Blender System Locking Mechanisms And Switch Assemblies,” which is hereby incorporated by reference in its entirety including the drawings.

### TECHNICAL FIELD

The present specification generally relates to blender systems for locking a container and a blade base to a blender base and, more specifically, switch assemblies for detecting proper attachment of the container and the blade base to the blender base.

### BACKGROUND

Blenders are widely used kitchen appliances for mixing, pureeing, or emulsifying food and beverages. A typical blender consists of a blender base containing a motor, a detachable container for holding the ingredients, and a removable blade base that fits into the container for processing. The secure attachment of the container and the blade base to the blender base allows for blender operation. If the components are not properly aligned or securely fastened, the blender may not function as intended. Existing solutions often involve simple twist-and-lock designs that may not adequately detect whether the container and the blade base are properly secured, or rely on separate mechanisms that do not provide integrated feedback to the blender’s control system.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a front view of a blender system, according to one or more aspects shown and described herein;

FIG. 2A schematically depicts a top perspective view of a blender base of a blender system, according to one or more aspects shown and described herein;

FIG. 2B schematically depicts a top plan view of the blender base of FIG. 2A, according to one or more aspects shown and described herein;

FIG. 3 schematically depicts a partial front view of a container engaging a blade base of the blender system, according to one or more aspects shown and described herein;

FIG. 4 schematically depicts a partial perspective cross-sectional view of the container engaging the blade base of FIG. 3, according to one or more aspects shown and described herein;

FIG. 5 schematically depicts a front perspective view of a switch assembly of the blender system, according to one or more aspects shown and described herein;

FIG. 6 schematically depicts a rear perspective view of the switch assembly of FIG. 5, according to one or more aspects shown and described herein;

FIG. 7 schematically depicts an elevated view of an actuator of the switch assembly of FIG. 5, according to one or more aspects shown and described herein;

FIG. 8 schematically depicts a partial cross-sectional front view of the blender base of FIG. 2A with an actuator of a switch assemblies in a raised position, according to one or more aspects shown and described herein;

FIG. 9 schematically depicts a partial cross-sectional front view of the blender base of FIG. 2A with the container and the blade base of FIG. 3 engaged with the blender base to push the actuator of the switch assemblies into a lowered position, according to one or more aspects shown and described herein;

FIG. 10 schematically depicts a circuit diagram illustrating a switch of the switch assembly electrically coupled to a control board and a motor, according to one or more aspects shown and described herein;

FIG. 11 schematically depicts an exploded front perspective view of another aspect of a blender system, according to one or more of the aspects shown and described herein;

FIG. 12 schematically depicts a bottom perspective view of a container of the blender system of FIG. 11, according to one or more of the aspects shown and described herein;

FIG. 13A schematically depicts a top perspective view of a blade base of the blender system of FIG. 11, according to one or more of the aspects shown and described herein;

FIG. 13B schematically depicts a bottom perspective view of the blade base of the blender system of FIG. 11, according to one or more of the aspects shown and described herein;

FIG. 14A schematically depicts a top plan view of an adapter of the blender system of FIG. 11, according to one or more aspects shown and described herein;

FIG. 14B schematically depicts a bottom plan view of the adapter of the blender system of FIG. 11, according to one or more aspects shown and described herein;

FIG. 15A schematically depicts a partial cross-sectional front view of the blender system of FIG. 11 including the blade base of FIG. 13 and the container of FIG. 12 disengaged with a blender base, according to one or more of the aspects shown and described herein; and

FIG. 15B schematically depicts a partial cross-sectional view of the blender system of FIG. 11 with the blade base of FIG. 13 and the container of FIG. 12 engaged with the blender base, according to one or more aspects shown and described herein.

### DETAILED DESCRIPTION

Standard blender systems oftentimes lack mechanisms, such as appropriate locking mechanisms, configured to ensure proper alignment or secure fastening between the components of the blender system. Proper alignment may be necessary for the blender system to function as intended. As such, there is a need for an improved locking mechanism that ensures that the container and the blade base are securely attached to the blender base, preventing operation when these components are not properly engaged.

Reference will now be made in detail to exemplary aspects of the present disclosure, examples of which are illustrated in the accompanying drawings. It is to be understood that other aspects may be utilized and structural and functional changes may be made without departing from the respective scope of the present disclosure. Moreover, features of the various aspects may be combined or altered without departing from the scope of the present disclosure. As such, the following description is presented by way of illustration only and should not limit in any way the various alternatives and modifications that may be made to the illustrated aspects and still be within the spirit and scope of the present disclosure.

Aspects described herein are directed to a blender system that includes a locking mechanism for inhibiting improper connection of a container and a blade base with a blender base. Additionally, the blender system includes one or more switch assemblies, each including an actuator. The actuator is movable in response to the relative position of the container, the blade base, and/or the blender base. In a raised position, the actuator may contact the container when the container is appropriately attached to the blade base, and the container and blade base are appropriately positioned on the blender base. The blender base may determine the position of the actuator to confirm whether or not the container and the blade base are appropriable assembled. In response to determining whether or not the container and the blade base are appropriately assembled and positioned on the blender base, the blender base may inhibit power from being delivered to the motor or may allow delivery of power to the motor.

Various aspects of the blender systems and the operation of the blender systems are described in more detail herein. The same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein - for example up, down, right, left, front, back, top, bottom, upper, lower - are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of aspects described in the specification.

As used herein, the singular forms “a,” “an” and “the” include plural referents unless the context clearly dictates otherwise. Thus, for example, reference to “a” component includes aspects having two or more such components, unless the context clearly indicates otherwise. As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

As used herein, the words “properly aligned”, “proper alignment”, or the like mean that one or more features of the present disclosure are arranged in a coordinated position or arrangement. As another matter, the words “properly secured”, “properly engaged”, or “proper engagement mean that one or more features of the present disclosure are attached or fastened in a coordinated alignment to prevent movement or disengagement.

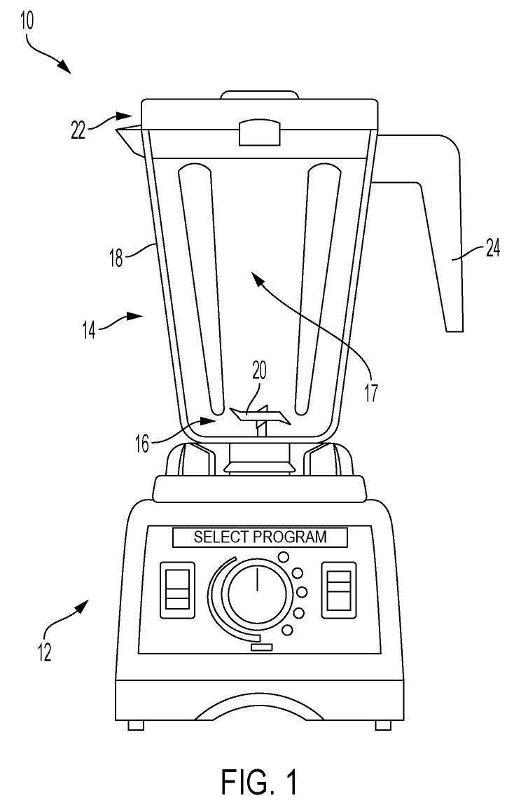

Referring now to FIG. 1, an illustrative blender system 10 according to various aspects is generally depicted. The blender system 10 may incorporate a blade base and a container including a locking mechanism, as described in greater detail herein. The blender system 10 depicted in FIG. 1 is provided for context only, and the sound dampening components described herein are not limited to this implementation. For example, blender system 10 may include a large format container, or other blending container as described herein. In addition, the blender system 10 may allow for interchangeable containers.

As shown in FIG. 1, the blender system 10 includes a blender base 12 and a container 14, operatively attachable to a blade base 16, which is operatively attached to the blender base 12. The container 14 includes walls 18 that define an interior cavity 17 in which a blade 20 of the blade base 16 is received. As shown in FIG. 1, the blender system 10 includes a lid 22 that may be operatively attached to the container 14 to enclose the interior cavity 17 defined by the walls 18. However, it should be appreciated that the blender system 10 may not include the lid 22 such that the container 14 is open at the top end. The container 14 may further include a handle 24. Foodstuff may be added to the interior cavity 17 of the container 14 for blending. The container 14 may be formed from one or more materials such as, but not limited to, plastics, glass, metals, or the like. In another aspect, container 14 may be powered in any appropriate manner, such as by components within the blender base 12, as described herein.

As described in more detail herein, the blade base 16 is removably couplable to the container 14. In addition, the container 14 may be removable couplable to the blender base 12. The blade base 16 may be rotated, moved, or the like by an external source, such as by a motor or the like.

While the container 14 depicted in FIG. 1 is shown as a large-format system, the container 14 may be a single serving style container, such as for example, of a type where the container 14 is filled, the blade base 16 is attached to the container 14, and the container 14 is inverted and placed on the blender base 12 for blending. As can be appreciated, the container 14 depicted in FIG. 1 is only one illustrative shape, and the container 14 may be a different size and/or shape without departing from the scope of the present disclosure.

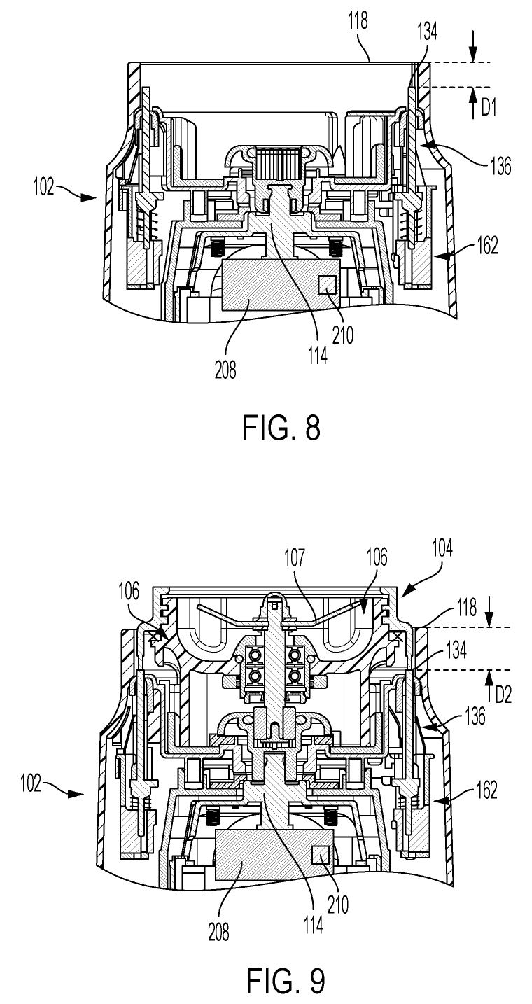

The blender base 12 includes a motor 114 (e.g., as shown and described herein with respect to FIG. 8) and a power source 208 (e.g., as shown and described herein with respect to FIG. 8) that is electrically coupled to the motor. In some aspects, the motor 114 may be, but not limited to, an electric motor or the like. The power source 208 includes a switch 210 (e.g., as shown and described herein with respect to FIG. 8) that is configured to inhibit power from being delivered from the power source 208 to the motor 114. As described in more detail herein, the motor 114 selectively drives the blade 20 of the blade base 16 when the blade base 16 is properly interfaced with the container 14 and the blender base 12. As a result, the blade base 16 may agitate, or otherwise interact with contents within the interior cavity 17 of the container 14.

As described in more detail herein, the blender system 10 may identify or detect whether the blender system 10 is interlocked through mechanical detection (e.g., push rods), user input, image recognition, magnetic detection (e.g., reed switches), electronic detection (e.g., inductive coils, a near-field communication (NFC) component), or the like.

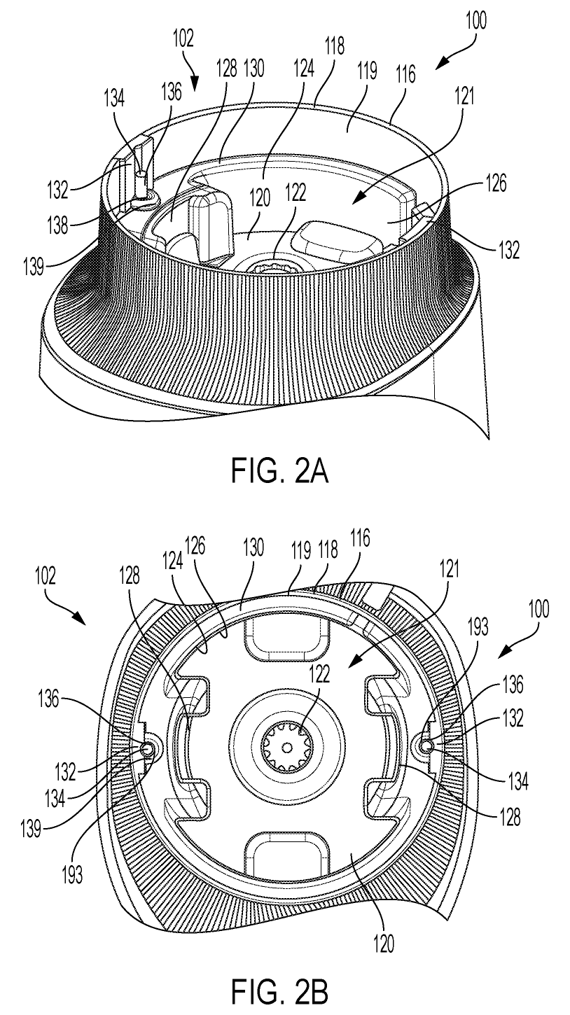

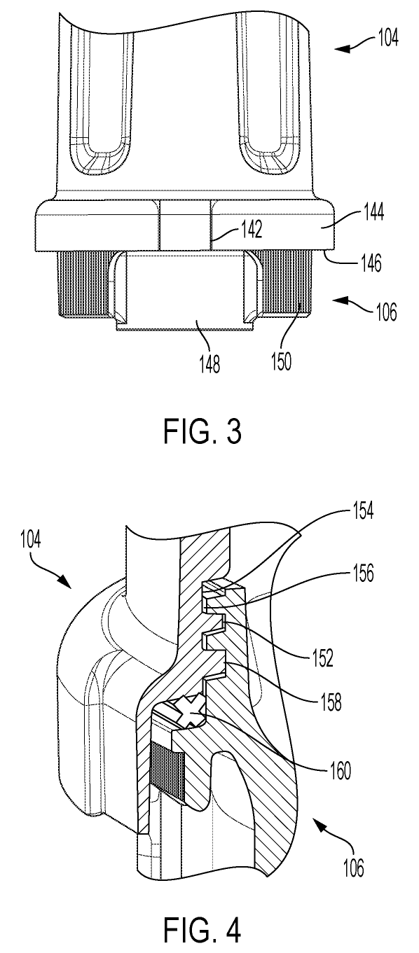

Referring now to FIGS. 2A and 2B, a blender base 102 of a blender system 100 (assembled in FIG. 9) is illustrated. It is noted that like-named components of FIGS. 2A and 2B and those of the other figures may comprise similar aspects or functionality, unless context suggests otherwise or warrants a particular distinction among the terms. For instance, blender base 102 and blender base 12 may include similar or the same components. The blender base 102 includes a blender base body 116 having a pedestal 118. The pedestal 118 may be of any appropriate shape and size. By way of a non-limiting example, the pedestal 118 may be sized and shaped to cooperate with a blade base 106 (FIG. 3) as described herein. The pedestal 118 may define an opening 119and may include one or more side walls 124 and a receiving surface 120 defining a receiving cavity 121 in which a container 104 (FIG. 3) and/or the blade base 106 (FIG. 3) are received, as described in more detail herein. A coupler 122, such as a splined couple, is disposed at the receiving surface 120. The one or more side walls 124 is provided on an inner surface 126 of the blender base body 116 and extends inwardly. In aspects, the one or more side walls 124 includes one or more lower protrusions 128 extending inward. As shown, a total of six lower protrusions 128 are depicted. However, it should be appreciated that any number of lower protrusions 128 may be provided. Additionally, as shown, opposite ends of the lower protrusions 128 may be tapered, sloped, chamfered, or the like. The lower protrusions 128 extend between the receiving surface 120 of the blender base 102 and an upper ledge 130 formed between the one or more side walls 124 and the inner surface 126.

In aspects, one or more upper protrusions 132 may be formed on the inner surface 126 of the blender base body 116 above the upper ledge 130 of the one or more side walls 124. As shown, a plurality of upper protrusions 132 are depicted and equidistantly spaced apart from one another. However, it should be appreciated that any number of upper protrusions 132 may be provided.

Referring still to FIGS. 2A and 2B, the blender system 100 may include one or more actuators 136 disposed within the receiving cavity 121. The actuators 136 may operatively interact with the container 104 (FIG. 3) and/or the blade base 106 (FIG. 3) as described herein. In at least one embodiment, the actuators 136 may comprise plungers that are biased in a first position, such as by a magnet, spring, etc. According to an example, the actuators 136 may include an upper end 134 and may extended through apertures 138 formed in the upper ledge 130 of the one or more side walls 124. In other aspects, the actuators may be hermetically sealed and may include an elastomeric material that allows the actuators 136 to be depressed.

In various aspects, the upper ledge 130 of the blender base 102 further includes a nub 139 that assists in aligning the blender base 102 with the blade base 106 (FIG. 3) when positioned thereon. The nub 139 may be a mating feature that cooperates with recessed features defined along the blade base 106 (FIG. 3). When the nubs 139 align with the recessed features of the blade base 106, the nubs 139 inhibit rotation of the blade base 106 and the container 104 (FIG. 3). These anti-rotational properties assist in preventing disengagement of the blade base 106 with the blender base 102 during operation. Additionally, this prevents the blades 107 of the blade base 106 from being exposed during operation of the blender system 100.

As shown, a pair of nubs 139 are depicted on opposite sides of the blender base 102. However, it should be appreciated that any number, including, but not limited to, one or more than two nubs 139 may be provided. Additionally, as shown, the nub 139 is depicted as a half-sphere extending outward from the upper ledge 130 and the upper protrusion 132 of the blender base 102. However, it should be appreciated that the nub 139 may be any appropriate size or shape. By way of a non-limiting example, the nubs 139 may be sized and shaped to cooperate with the recessed features of the blade base 106.

In other aspects, the upper protrusions 132 may be a mating feature that cooperates with recessed features of the container 104 (FIG. 3), such as one or more container notches 142 (FIG. 3). When the upper protrusions 132 align with the container notches 142 of the container 104, the upper protrusions 132 facilitate a locking of the container 104 and inhibit rotation of the blade base 106 and the container 104. These anti-rotational properties assist in preventing disengagement of the container 104 with the blender base 102 and the blade base 106 during operation. Additionally, this prevents the blades 107 of the blade base 106 from being exposed during operation of the blender system 100.

In similar aspects, the lower protrusions 128 may be a mating feature that cooperates with recessed features of the blade base 106 (FIG. 3), such as one or more blade notches 148 (FIG.3). When the lower protrusions 128 align with the blade notches 148 of the blade base 106, the lower protrusions 128 facilitate a locking of the blade base 106 and inhibit rotation of the blade base 106 and the container 104. The anti-rotational properties assist in preventing disengagement of the blade base 106 with the blender base 102 during operation. Additionally, this prevents the blades 107 of the blade base 106 from being exposed during operation of the blender system 100.

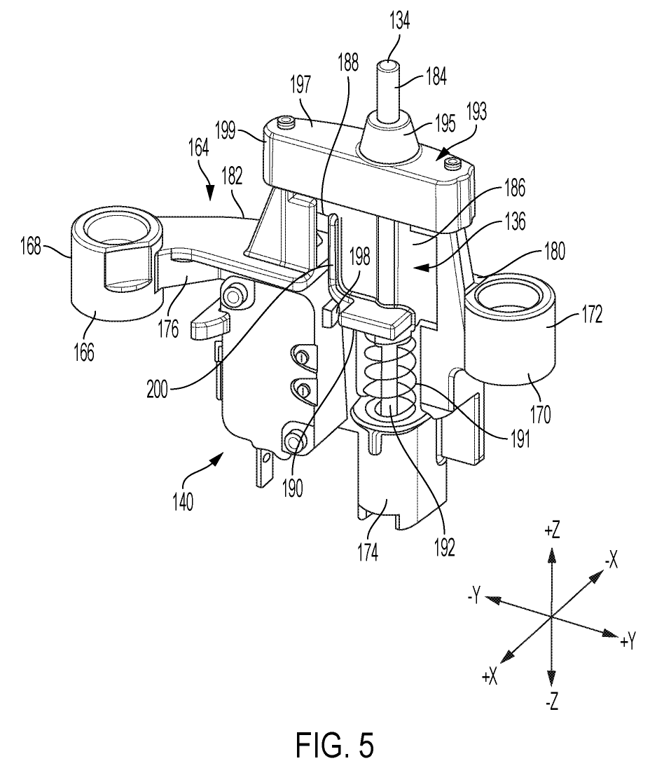

As described in more detail herein, the container 104 (FIG. 3), when properly engaged with the blade base 106, depresses the upper end 134 of the actuators 136 and activates a switch 140 (FIG. 5), which permits power to be provided to a blade (such as blade 107 of the blade base 106 shown in FIG. 9) from the motor 114 housed within the blender base 102. As shown, a set of actuators 136 are provided within the receiving cavity 121 of the blender base 102. However, it should be appreciated that any number of actuators 136 may be provided, for example, one actuator 136 or more than two actuators 136. Utilizing a plurality of actuators 136 ensures that the container 104 and the blade base 106 are properly seated within the receiving cavity 121 of the blender base 102 prior to permitting the blade 107 to be operated by the motor 114. It should be appreciated that the actuators 136 are not accessible when the blade base 106 is installed on the blender base 102.

Referring now to FIG. 3, the container 104 is shown engaging the blade base 106. The container 104 and the blade base 106 may be aligned to permit the container 104 to engage the blade base 106. Specifically, the container 104 includes one or more container notches 142 formed in an outer surface 144 of the container 104. The container notches 142 intersect a lower edge 146 of the container 104. Additionally, the blade base 106 includes one or more blade notches 148 formed in an outer surface 150 of the blade base 106. In aspects, the container notches 142 may be aligned with the blade notches 148 to permit the container 104 to engage the blade base 106. Accordingly, the container notches 142 and the blade notches 148 serve as a visual indicator that the container 104 and the blade base 106 are aligned with each other in the proper position. However, the container notches 142 and the blade notches 148 may not necessarily connect the container 104 and the blade base 106 to one another. Rather, the container notches 142 and the blade notches 148, when properly aligned and tightened, the container 104 and the blade base 106 are permitted to fit onto the blender base 102 (FIG. 1). Alternatively, if the container notches 142 and the blade notches 148 are not properly aligned and tightened, the container 104 and the blade base 106 are inhibited from fitting onto the blender base 102 (FIG. 1) as the container notches 142 and the blade notches 148 will not align with corresponding features in the blender base 102 (FIG. 1).

With the container 104 aligned with the blade base 106, the container 104 may be rotated to further engage threads 152 formed on an inner surface 154 of the container 104 with threads 156 formed on an outer surface 158 of the blade base 106, as shown in FIG. 4 with the container 104 illustrated as being partially transparent. In aspects, the container 104 is rotated onto the blade base 106 in a clockwise direction to further engage the threads 152 with the threads 156. In such aspects, the motor 114 within the blender base 102 is configured to rotate in a counterclockwise direction to ensure that the container 104 does not disengage the blade base 106 during operation. In other aspects, the container 104 is rotated onto the blade base 106 in a clockwise direction to further engage the threads 152 with the threads 156. In such aspects, the motor 114 within the blender base 102 is configured to rotate in a clockwise direction to ensure that the container 104 does not disengage the blade base 106 during operation. As shown, a gasket 160 is provided between the container 104 and the blade base 106, specifically below the threads 152 of the container 104 and the threads 156 of the blade base 106. In aspects, the gasket 160 has an X-shaped cross-sectional geometry to allow for sealing and venting.

Referring again to FIGS. 2 and 3, the lower protrusions 128 are configured to be received within the blade notches 148, and the upper protrusions 132 are configured to be received within the container notches 142. Accordingly, with the container 104 and the blade base 106 received within the receiving cavity 121 of the blender base 102, the container 104 and the blade base 106 are not permitted to rotate relative to the blender base 102.

Referring now to FIG. 5, a switch assembly 162 including the actuator 136 is depicted. The switch assembly 162 includes a switch frame 164, the actuator 136 movably mounted on the switch frame 164, and the switch 140 mounted on the switch frame 164 configured to be selectively engaged by the actuator 136.

The switch frame 164 includes a mounting portion 166 provided at a first side end 168 of the switch frame 164, a switch holding bracket 170 provided at a second side end 172 of the switch frame 164 opposite the first side end 168, and a first actuator receiving portion 174 provided on a front surface 176 of the switch frame 164 between the mounting portion 166 and the switch holding bracket 170. The mounting portion 166 is utilized to mount the switch frame 164 to the blender base 102 (FIG. 2A). In aspects, a fastener extends through the mounting portion 166 to secure the switch frame 164 to the blender base 102. Similarly, the switch holding bracket 170 is utilized to mount the switch frame 164 to the blender base 102. In aspects, a fastener extends through the switch holding bracket 170 to further secure the switch frame 164 to the blender base 102.

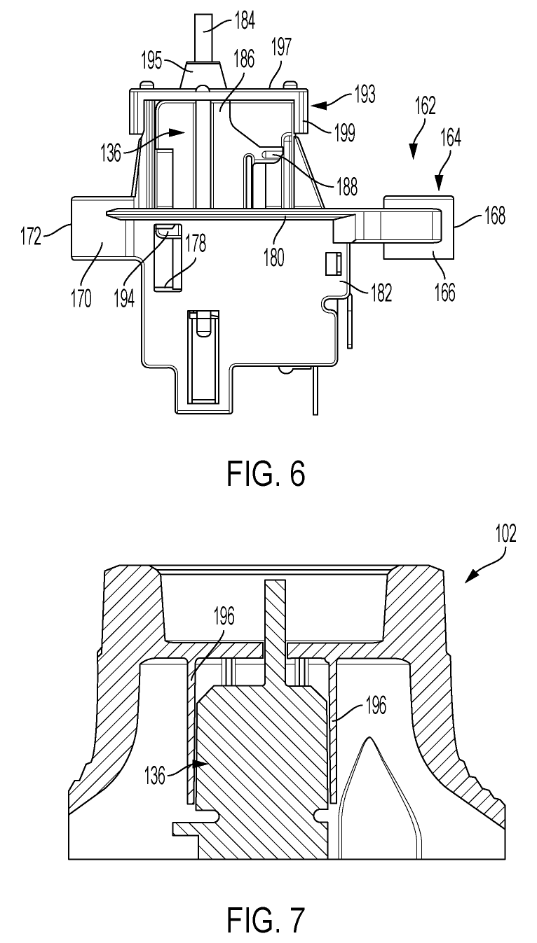

In aspects, a hard stop 178 (FIG. 6) is formed on the switch frame 164 above the first actuator receiving portion 174 between the mounting portion 166 and the switch holding bracket 170. Additionally, as shown in FIG. 6, the switch frame 164 includes a second actuator receiving portion 180 formed on a rear surface 182 of the switch frame 164 opposite the front surface 176.

Referring again to FIG. 5, the actuator 136 includes an upper post 184 including the upper end 134 illustrated in FIG. 2A, an actuator plate 186 having a finger 188 and a lower surface 190, and a lower post 192 extending from the lower surface 190 of the actuator plate 186. As shown, the lower post 192 is received within the first actuator receiving portion 174. The actuator 136 is positionable between a raised position, as shown in FIG. 5, and a lowered position. A biasing member 191, for example a spring, circumscribes the lower post 192 and abuts against the lower surface 190 of the actuator plate 186 at an upper end of the spring and the first actuator receiving portion 174 at a second end of the spring opposite the first end of the spring. Accordingly, the spring provides a biasing force urging the actuator 136 toward the raised position when a force applied against the upper end 134 of the actuator 136 is less than a force applied onto the actuator plate 186 by the spring. Additionally, the actuator plate 186 further includes a flange 200. The flange 200 extends outward in a first direction from the actuator plate 186 and is connected to the lower surface 190 of the actuator plate 186. As shown, the flange 200 is L-shaped and extends outward in the (-Z direction of the coordinate axes of FIG. 5) from the actuator plate 186. However, it should be appreciated that the flange 200 may be any appropriate size or shape.

As described in more detail herein, the lower surface 190 of the actuator plate 186 is configured to contact the hard stop 178 (FIG. 6) formed on the switch frame 164 to prevent overextension of the actuator 136 relative to the switch frame 164 as the actuator 136 moves from the raised position to the lowered position. The actuator 136 moves in a downward vertical direction (e.g., -Z direction of the coordinate axes of FIG. 5) as the actuator 136 moves from the raised position to the lowered position. Additionally, the actuator 136 moves in an opposite upward vertical direction (e.g., +Z direction of the coordinate axes of FIG. 5) as the actuator 136 moves from the lower position to the raised position. The upward vertical direction and downward vertical direction defines a moving direction of the actuator 136. As shown in FIG. 6, a rear extension 194 of the actuator plate 186 engages the second actuator receiving portion 180 to ensure vertical alignment of the actuator 136 relative to the switch holding bracket 170.

In aspects, a seal 193 is provided at an upper end portion of the actuator plate 186 and circumscribes a portion of the upper post 184 of the actuator 136. The seal 193 includes a tapered portion 195 extending from an upper surface 197 of a body 199 of the seal 193. The tapered portion 195 circumscribing the upper post 184. Opposite ends of the body 199 of the seal 193 are slidably engaged with the switch frame 164. The actuator 136 is permitted to slide in the vertical direction within the switch frame 164 relative to the seal 193.

Referring now to FIG. 7, in aspects, the actuator 136 is illustrated engaged within the blender base 102. Specifically, the blender base 102 includes one or more ribs 196 provided on opposite sides of the actuator plate 186 to ensure vertical alignment of the actuator 136 relative to the switch holding bracket 170. As shown, a pair of ribs 196 are depicted. However, it should be appreciated that any number, including, but not limited to, one or more ribs 196 may be provided. In other aspects, alignment features may be built into the switch frame 164 itself.

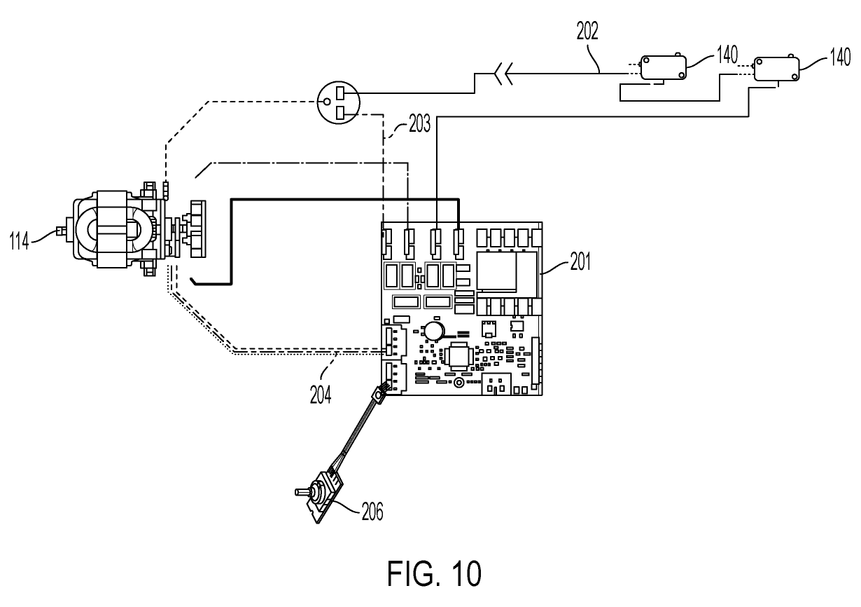

Referring again to FIG. 5, the switch 140 is shown provided on the front surface 176 of the switch frame 164. The switch 140 includes a trigger 198 electrically coupled to a control board 201 (FIG. 10). With the actuator 136 in the raised position, as shown, the trigger 198 is not contacted by the actuator 136. As the actuator 136 moves from the raised position to the lowered position, the flange 200 of the actuator plate 186 contacts the trigger 198 to move the trigger 198 in a corresponding direction, which results in a signal being sent to the control board 201. Specifically, the flange 200 is configured to engage with the trigger 198 of the switch 140 and depress the trigger 198 in a direction opposite to the actuator plate 186 and in a direction transverse to the moving direction of the actuator plate 186. As shown, when the actuator 136 is moved from the raised position to the lowered position, the actuator plate 186 moves in the downward vertical direction, (e.g., -Z direction of the coordinate axes of FIG. 5). During this movement, the flange 200 contacts the trigger 198 and depresses the trigger 198 in a transverse lateral direction, (e.g., -Y direction of the coordinate axes of FIG. 5).

As described herein, a set of switch assemblies 162 is provided. In aspects, when the control board 201 receives a signal from each of the set of switch assemblies 162 that the triggers 198 are engaged, the control board 201 energizes the motor 114 (FIG. 10) to operate the blade 107 (FIG. 9). In other aspects, the when each of the actuators 136 are in the lowered position to engage the respective triggers 198, a signal is sent to energize the control board 201. However, the control board 201 is only operated to energize the motor 114 (FIG. 10) once a potentiometer on the user interface is operated in a blending mode. Once either of the actuators 136 are no longer in the lowered position such that the trigger 198 is no longer engaged, the control board 201 de-energizes the motor 114 to deactivate the blade 107.

Referring now to FIG. 8, the blender base 102 is shown without the container 104 and the blade base 106. The blender base 102 includes a motor 114 and a power source 208 that is electrically coupled to the motor 114. In some aspects, the motor may be, but is not limited to, an electric motor or the like. The power source includes a switch 210 that is configured to inhibit power from being delivered from the power source 208 to the motor 114. Accordingly, the actuator 136 of the switch assembly 162 is in the raised position. In the raised position, the upper end 134 of each actuator 136 is shown extended above the upper ledge 130 of the one or more side walls 124. With the actuators 136 in the raised position, the upper end 134 of the actuators 136 is provided below the pedestal 118 of the blender base body 116 by a first distance D1. Additionally, as shown in FIG. 8 with the actuators 136 in the raised position, the lower surface 190 of the actuator plate 186 contacts the receiving surface 120 of the blender base 102 to prevent overextension of the actuator 136.

Referring now to FIG. 9, the blender base 102 is shown with the container 104 and the blade base 106 received within the receiving cavity 121 of the blender base 102. Accordingly, the lower edge 146 of the container 104 abuts against the upper end 134 of the actuator 136 of each switch assembly 162 to position the actuators 136 into the lowered position. In the lowered position, the upper end 134 of the actuators 136 is shown recessed below the upper ledge 130 of the one or more side walls 124. With the actuators 136 in the lowered position, the upper end 134 of the actuators 136 is provided below the pedestal 118 of blender base body 116 by a second distance D2 greater than the first distance D1. In aspects, the total stroke of the actuator 136, e.g., the difference between the first distance D1 and the second distance D2, is about 0.25 inches (in) +/- 30%. In aspects, the total stroke of the actuator 136 is 0.25 in. +/- 20%. In aspects, the total stroke of the actuator 136 is 0.10 in. +/- 20%. In aspects, the total stroke of the actuator 136 is 0.15 in. +/- 30%. In aspects, the total stroke of the actuator 136 is 0.15 in. +/- 20%. In aspects, the total stroke of the actuator 136 is 0.15 in. +/- 10%. In aspects, the total stroke of the actuator 136 is greater than or equal to 0.1 inches and less than or equal to 0.4 inches. In aspects, the total stroke of the actuator 136 is greater than or equal to 0.2 inches and less than or equal to 0.3 inches.

Referring now to FIG. 10, a circuit diagram is depicted including the set of switches 140 of the switch assemblies 162 (FIG. 5) communicatively coupled to the control board 201 and the motor 114. As shown, the switches 140 are electrically connected in series to each other. A hot lead 202 from an external alternating current (AC) source runs through each switch 140 before connecting to the control board 201. A neutral wire 203 from the wall AC runs directly to the control board 201. The control board 201 then connects to the motor 114 to provide power to the motor 114. A Tach wire 204 connects the control board 201 to the motor 114 and determines the revolutions per minute (RPM) of the motor 114. The determined RPM is then provided to the control board 201 via the Tach wire 204 for feedback purposes. A POT/Switch 206 is communicatively coupled to the control board 201. The POT/Switch 206 is used to select a pre-programmed blend setting, variable speed settings, and/or to stop the motor 114 from running.

In operation, if either switch 140 is in an open position such that the actuator 136 (FIG. 5) is in the raised position, the control board 201 is operated to inhibit power from being delivered to the motor 1144. Alternatively, if both switches 140 are closed such that the actuators 136 (FIG. 5) are each in the lowered position, power is supplied to the control board 201, but not output to the motor 114 until the potentiometer is operated in a blending mode.

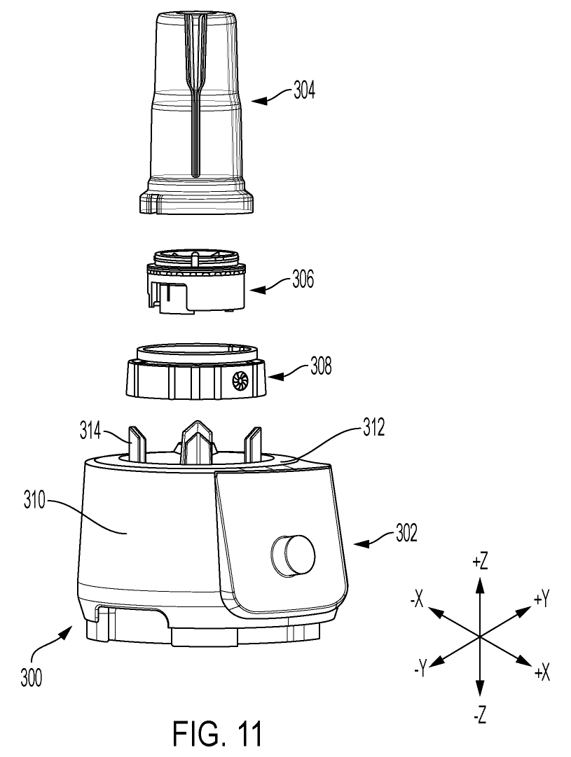

Referring now to FIG. 11, another embodiment of a blender system 300 is depicted. The blender system 300 includes a blender base 302, a container 304, a blade base 306, and an adapter 308. It is noted that like-named components of FIG. 11 and those of other figures may comprise similar aspects or functionalities, unless context suggests otherwise or warrants a particular distinction among the terms. For instance, the blender base 302 may have similar or the same components as the blender base 102 or the blender base 12. The container 304 is operatively attachable to the blade base 306, which is operatively attached to the adapter 308, which is further operatively attached to the blender base 302.

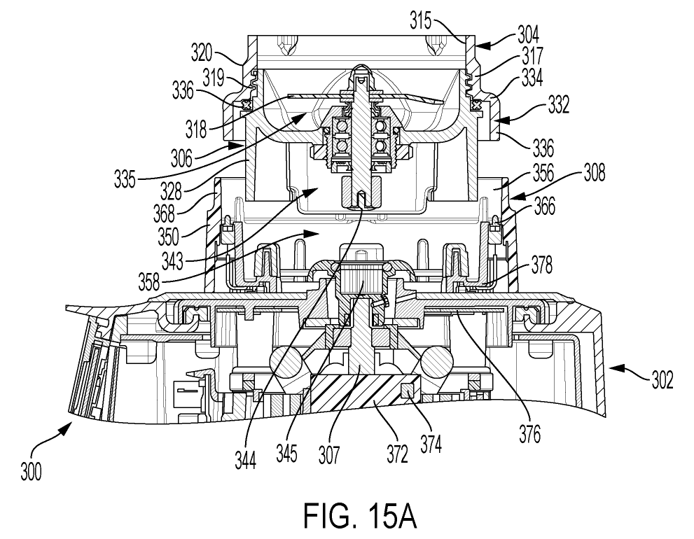

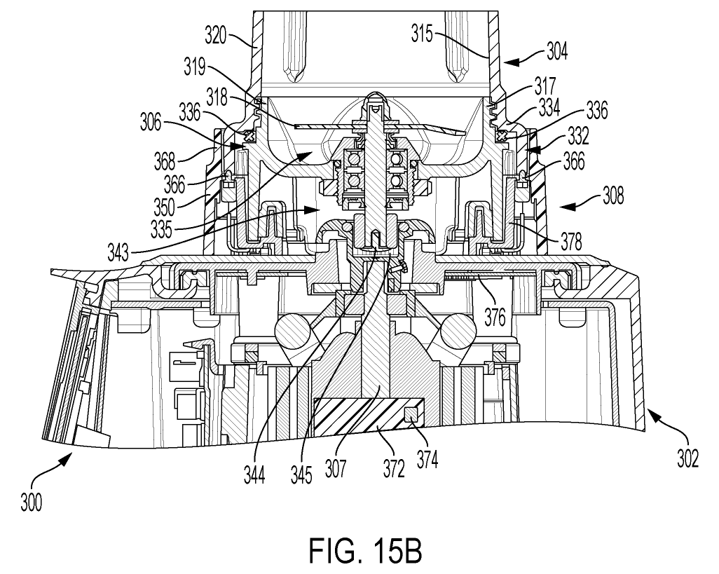

As described in more detail herein, the blade base 306 is removably coupled to the container 304. In addition, the container 304 may be removably coupled to the adapter 308, which may be removably coupled to the blender base 302. The blade base 306 may be rotated, moved, or the like by an external source, such as a motor 307 (FIG. 15A) or the like.

The blender base 302 includes a blender base body 310 that includes one or more exterior walls 312. The blender base body 310 further includes a plurality of protrusions 314 that extend outward orthogonally from the one or more exterior walls 312. The plurality of protrusions 314 may be of any appropriate shape and size. By way of a non-limiting example, the plurality of protrusions 314 may be sized and shaped to cooperate with the adapter 308, further described herein. In the present aspect, the plurality of protrusions 314 is depicted as extending in the upward vertical direction, (e.g., +Z direction of the coordinate axes of FIG. 11) away from the exterior wall 312. The plurality of protrusions 314 may be tapered, sloped, chamfered, or the likes. Additionally, the plurality of protrusions 314 may be formed from one or more materials, including but not limited to, plastic, metal, rubber, or the like. Furthermore, the plurality of protrusions 314 are depicted in the present aspect as four elements equidistantly spaced apart from one another. However, it should be appreciated that any number of protrusions 314 may be provided, including but not limited to, one or more protrusions 314.

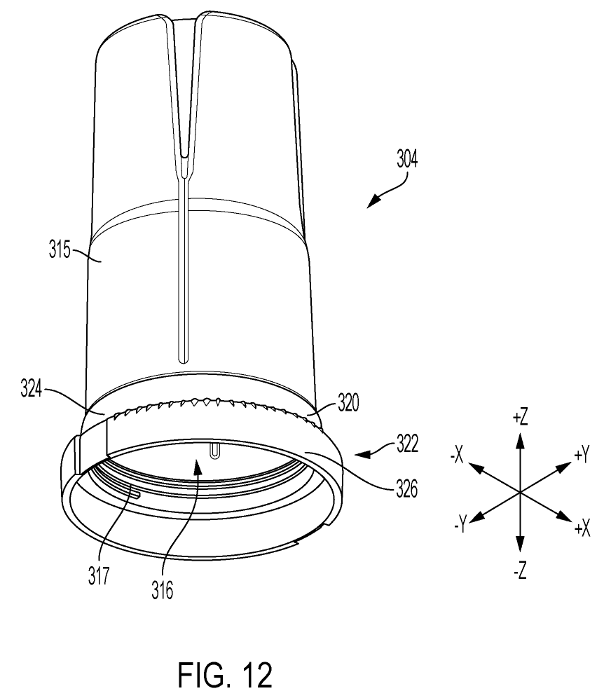

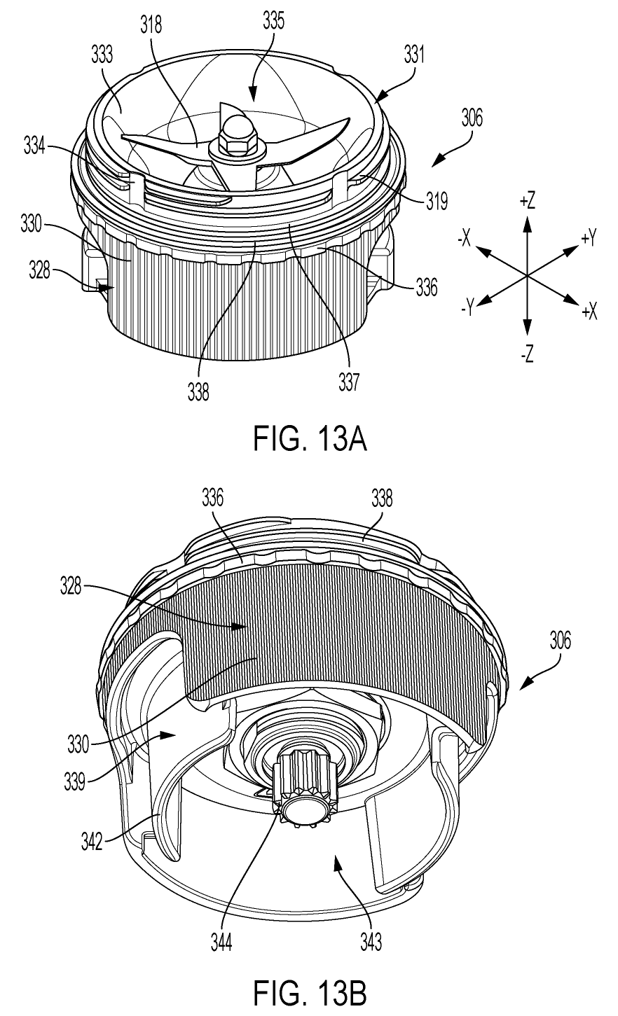

Referring now to FIG. 12, the container 304 is shown separate from the other components of the blender system 300 illustrated in FIG. 11. The container 304 includes one or more side walls 315 that define an interior cavity 316 in which a blade 318 (FIG. 13) of the blade base 306 is received. Foodstuff may be added to the interior cavity 316 of container 304 for blending. The container 304 may be formed from one or more materials such as, but not limited to, plastics, glass, metals, or the like. In some aspects, then container 304 may be a single serve style container or a mixing bowl.

The one or more side walls 315 of the container 304 further include threads 317 that are engageable with threads 319 (FIG. 13A) of the blade base 306. In other aspects, the container 304 may include an outer surface 320 and the threads 317 are provided on the outer surface 320 and engageable with the threads 319 of the blade base 306, which may be provided on an inner surface of the blade base 306. In some aspects, the alignment and engagement of the container 304 to the blade base 306 is facilitated by threads 317, 319.

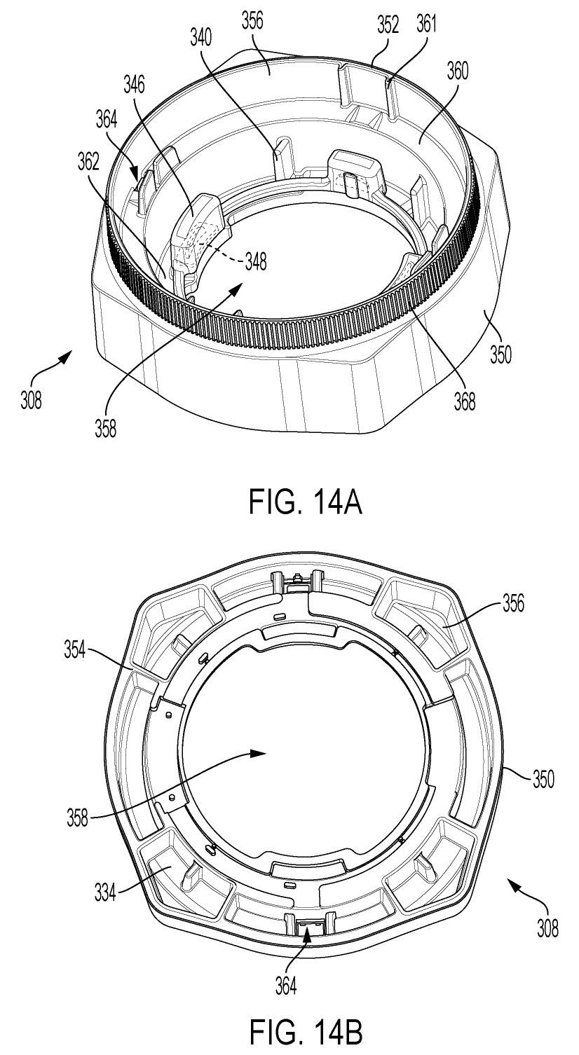

Still referring to FIG. 12, the container 304 further includes a flange 322. As described in more detail below, the flange 322 of the container 304 is configured to engage with the switch assembly 366. The flange 322 further includes a first portion 324 and a second portion 326 extending from the first portion 324. The first portion 324 of the flange 322 extends outwardly in a first direction from the one or more side walls 315 of the container 304. As shown, the first portion 324 of the flange 322 extends in an outward lateral direction, (e.g., +Y direction of the coordinate axes in FIG. 12) relative to the one or more side walls 315 of the container 304. Additionally, the second portion 326 of the flange 322 extends from the first portion 324 in a second direction that is orthogonal to the first direction. As shown, the second portion 326 extends in a downward vertical direction, (e.g., -Z direction of the coordinate axes in FIG. 12) relative to the first portion 324 of the flange 322. However, it should be appreciated that the flange 322 may be any appropriate size or shape. The second portion 326 of the flange 322 further includes one or more container notches 327. In various aspects, the container notches 327 may be aligned with one or more adapter notches 361 (FIG. 14A) to permit the container 304 to engage the adapter 308 (FIG. 14A).

Referring now to FIG. 13A, the blade base 306 is shown separate from the other components of the blender system 300 illustrated in FIG. 11. The blade base 306 includes a blade base body 328 that includes one or more side walls 330 that includes an upper end 331 and a lower end 332 (FIG. 13B) opposite the upper end 331. As shown, the upper end 331 extends in an upward vertical direction, (e.g., +Z direction of the coordinate axes in FIG. 13A) from the one or more side walls 330. Additionally, the lower end 332 extends in a downward vertical direction, (e.g., -Z direction of the coordinate axes in FIG. 13A) from the one or more side walls 330. However, it should be appreciated that these terms are not intended to imply that a particular orientation is required.

The one or more side walls 330 of the upper end 331 of the blade base 306 includes an inner surface 333 and an outer surface 334. In various aspects, the inner surface 333 of the one or more side walls 330 defines an upper cavity 335 that houses the blade 318 of the blade base 306. Additionally, the threads 319 are provided on the outer surface 334 of the one or more side walls 330.

In various aspects, the threads 319 of the blade base 306 are engageable with threads 317 (FIG. 12) of the container 304 (FIG. 12). In other aspects, the threads 319 are provided on the inner surface 333 of the one or more side walls 330 adjacent to the upper cavity 335 and are engageable with the threads 317 of the container 304. Furthermore, the one or more side walls 330 of the upper end 331 includes a lip 336 having an upper surface 337 facing the upper end 331 of the one or more side walls 330. A gasket 338 is positioned upon the upper surface 337 of the lip 336. The gasket 338 may assist in the sealing and venting of the container 304 and the blade base 306.

Referring now to FIG. 13B, a bottom perspective view of the blade base 306 is depicted. The side wall 330 further defines a one or more openings 339. The openings 339 may include a pair of openings 339, as shown, positioned opposite and equidistant from one another. The pair of openings 339 are configured to facilitate engagement between the blade base 306 and the adapter 308 (FIG. 14A). More specifically, the pair of openings 339 are utilized to position and secure the blade base 306 with a plurality of projections 340 of the adapter 308 (FIG. 14A). While the openings 339 are depicted as a pair, it should be understood that the blade base body 328 may define any number of openings 339, including, but not limited to, one or more openings 339.

The blade base 306 further includes one or more interior walls 342 that defines a lower cavity 343 that houses a blade coupler 344 of the blade base 306. The blade coupler 344 is engageable with a motor coupler 345 of the motor 307 of the blender base 302 (FIG. 15A) to operate the blade base 306 when the motor 307 is energized.

Referring now to FIGS. 14A, the adapter 308 is shown separate from the other components of the blender system 300 illustrated in FIG. 11. The adapter 308 includes an adapter body 350 that defines a top surface 352 and a bottom surface 354 (FIG. 12B) opposite the top surface 352. The top surface 352 may include one or more side walls 356 that define a receptacle 358. The receptacle 358 is configured to receive the container 304 (FIG. 12) and the blade base 306 (FIG. 13A). The one or more side walls 356 further includes one or more adapter notches 361. The one or more adapter notches 361 may be a mating feature that cooperates with recessed features of the container 304 (FIG. 12), such as the one or more container notches 327 (FIG. 12). When the adapter notches 361 align with the container notches 327, the adapter notches facilitate an alignment of the container 304 to the adapter 308, a locking of the container 304, and inhibit rotation of the container 304. These anti-rotational properties assist in preventing disengagement of the container 304 with the adapter 308 during operation. Additionally, this prevents the blades 318 of the blade base 306 from being exposed during operation of the blender system 300.

The receptacle 358 may be of any appropriate shape and size. By way of non-limiting example, the receptacle 358 may be sized and shaped to cooperate with the blade base 306 (FIG. 11). For example, in some aspects, the receptacle 358 is further defined by an upper ledge 360 and a lower ledge 362. In those aspects, the upper ledge 360 is configured to receive the container 304 (FIG. 11) and the lower ledge 362 is configured to receive the blade base 306 (FIG. 11). The upper ledge 360 further defines one or more holes 364 that houses a switch assembly 366 (FIG. 15A). As shown, a pair of holes 364 are depicted opposite and equidistant from one another. However, it should be appreciated that any number, including, but not limited to, one or more holes 364 may be provided. In other aspects, the one or more side walls 356 of the adapter 308 further include an exterior surface 368. In aspects, the switch assembly 366 may be deposited along the exterior surface 368 of the adapter 308.

Referring still to FIG. 14A, the lower ledge 362 of the adapter 308 further includes a centering pad 346, one or more raised members 348, and one or more projections 340. The centering pad 346 further includes a cavity that is engageable with the one or more raised members 348 to secure the centering pad 346. The raised members 348 may be of any appropriate shape and size. By way of non-limiting example, the raised members 348 may be sized and shaped to cooperate with the one or more cavities of the centering pad 346. As shown, a plurality of raised members 348 are depicted opposite and equidistantly spaced apart from one another. However, it should be appreciated that any number, including, but not limited to, one or more raised members 348 may be provided. Additionally, the position of the raised members 348 may differ in varying aspects while corresponding to the position of the cavities of the centering pad 346. The centering pad 346 is engageable with the interior wall 342 of the blade base 306 to assist in the prevention of undesirable noise during the operation of the blender system 300.

The one or more projections 340 are engageable with the openings 339 (FIG. 13B) of the blade base 306 (FIG. 13B) to facilitate positioning of the blade base 306 onto the adapter 308. The projections 340 may be any appropriate shape and size. By way of non-limiting example, the projections 340 may be sized and shaped to cooperate with the openings 339 of the blade base 306. As shown, a plurality of projections 340 are depicted opposite and equidistantly spaced apart from one another. However, it should be appreciated that any number, including, but not limited to, one or more projections 340 may be provided. Additionally, the position of the projections 340 may differ in varying aspects while corresponding to the position of the openings 339 of the blade base 306 without exceeding the scope of the aspect.

Referring now to FIGS. 14B, the bottom surface 354 of the adapter 308 may include one or more side walls 356 that define a recess 370. The recess 370 may be of any appropriate shape or size. By way of non-limiting example, the recess 370 may be sized and shaped to cooperate with the blender base 302 (FIG. 11). In some aspects, the recess 370 is configured to engage with the plurality of protrusions 314 of the blender base 302 (FIG. 11) to properly align the adapter 308 with the blender base 302. In the present aspect, the recess 370 is depicted as a plurality and are equidistantly spaced apart from one another. However, it should be appreciated that any number of recesses 370 may be provided, including, but not limited to, one or more recesses 370. It should also be appreciated that the number of recesses 370 may be, but do not need to be, equal to the number of protrusions 314 of the blender base 302.

In other aspects, an alternative arrangement may be provided such that the one or more protrusions 314 are formed on the bottom surface 354 of the adapter 308, and the recesses 370 are formed on the blender base 302. Accordingly, as the adapter 308 is positioned on the blender base 302, the protrusions 314 extending from the bottom surface 354 of the adapter 308 are received within the recesses 370 formed on the blender base 302.

Referring now to FIG. 15A, the adapter 308 is shown mounted onto the blender base 302, and the container 304 is shown mounted onto the blade base 306. However, the blade base 306 and the container 304 are disengaged from the adapter 308 and the blender base 302. As shown in FIG. 15B, the blade base 306 and the container 304 are shown engaged with the adapter 308 and the blender base 302.

As shown in FIG. 15A, the blender base 302 includes a motor 307 and a power source 372 that is electrically coupled to the motor 307. In some aspects, the motor 307 may be, but not limited to, an electric motor or the like. The power source 372 includes a switch 374 that is configured to inhibit power from being delivered from the power source 372 to the motor 307. As described in more detail here, the motor 307 selectively drives the blade 318 of the blade base 306 when the blade base 306 is properly interfaced with the container 304 and the adapter 308. As a result, the blade base 306 may agitate, or otherwise interact with contents within the interior cavity 316 of container 304.

Additionally, as described in more detail herein, the blender system 300 may identify or detect whether the blender system 300 is interlocked through mechanical detection (e.g., push rods), user input, image recognition, magnetic detection (e.g., reed switches), electronic detection (e.g., inductive coils or near-field communication (NFC) components), or the like. In aspects, as described in more detail herein, the blender base 302 further includes a near-field communication (NFC) receiver 376 that is electrically coupled to the switch 374 of the power source 372.

Still referring to FIG. 15A, the switch assembly 366 housed within the one or more holes 364 (FIG. 14A) of the adapter 308. As shown, a set of switch assemblies 366 are depicted. However, it should be appreciated that any number, including, but not limited to, one or more switch assemblies 366 may be provided. The switch assembly 366 may be an actuatable button, mechanical switch, or the like.

The adapter 308 further includes an NFC transmitter 378 that is electrically coupled to the switch assembly 366. As described in more detail herein, the NFC transmitter 378 is configured to transmit a signal to the NFC receiver 376 of the blender base 302 when the switch assembly 366 is actuated, e.g., depressed or otherwise contacts by the blade base 306. As shown, a set of NFC transmitters 378 are depicted. However, it should be appreciated that any number, including, but not limited to, one or more NFC transmitters 378 may be provided. By way of non-limiting example, the number of NFC transmitters 378 may, but is not required to, be equal to the number of switch assemblies 366.

Still referring to FIG. 15A, the container 304 is shown engaging the blade base 306. The container 304 and the blade base 306 may be aligned to permit the container 304 to engage with the blade base 306. When the container 304 and the blade base 306 are aligned, the container 304 may be rotated to further engage threads 317 of the container 304 with threads 319 of the blade base 306. In some aspects, the container 304 is rotated onto the blade base 306 in a clockwise direction. In such aspects, the motor 307 within the blender base 302 is configured to rotate in a counterclockwise direction to ensure that the container 304 does not disengage the blade base 306 during operation. In other aspects, the container 304 is rotated onto the blade base 306 in a clockwise direction. In such aspects, the motor 307 within the blender base 302 is configured to rotate in a counterclockwise direction to ensure that the container 304 does not disengage the blade base 306 during operation. As shown, the gasket 338 is provided between the container 304 and the blade base 306, specifically below the threads 317 of the container 304 and the threads 319 of the blade base 306. In some aspects, the gasket 338 has an X-shaped cross-sectional geometry to allow for sealing and venting.

Referring now to FIG. 15B, the flange 322 of the container 304 is configured to engage with the switch assembly 366 to operate the blender system 300. Additionally, the blade coupler 344 of the blade base 306 is configured to engage with the motor 307 housed within the blender base 302. In various aspects, the flange 322 of the container 304 will come into contact with the set of switch assemblies 366 synchronously with the blade coupler 344 of the blade base 306 engaging with the motor 307 housed within the blender base 302.

When the flange 322 of the container 304 comes into contact with the set of switch assemblies 366, the NFC transmitter 378 of the adapter 308 transmits a signal to the NFC receiver 376 of the blender base 302. It should be appreciated that the flange 322 of the container 304 coming into contact with the set of switch assemblies 366 may refer to, but is not limited to, direct contact, an application of force by the flange 322 upon the set of switch assemblies 366, the flange 322 coming within a predetermined distance of the set of switch assemblies 366, or the like. When the NFC receiver 376 receives a signal from the NFC transmitter 378, the NFC receiver 376 toggles the switch 374. Upon toggling the switch 374, the power source 372 is activated to energize the motor 307 to operate the blender system 300. In aspects where the power source 372 is activated, power is delivered to the motor 307 and the blade 318 of the blade base 306 is operated. In aspects where the signal from the NFC transmitter 378 is not received by the NFC receiver 376, the switch 374 is not toggled, the power source 372 is inactive, power is inhibited from reaching the motor 307, and the blade 318 of the blade base 306 is not operated.

Further aspects are provided by the subject matter of the following clauses:

According to a first aspect A1, a blender system includes a blender base; where the blender base includes an electric motor, a power source including a switch, where the power source is electrically coupled to the electric motor and operation of the switch inhibits power from being delivered from the power source to the electric motor, a blender base body including one or more side walls on an inner surface of the blender base body, a plurality of upper protrusions provided on an upper ledge of the one or more side walls, a plurality of lower protrusions extending inwardly from the one or more side walls, and a set of switch assemblies electrically coupled to the switch of the power source, where each switch assembly includes an actuator extending through the upper ledge of the one or more side walls, the actuators are movable between a raised and lowed position; a container engageable with the upper protrusions of the blender base body of the blender base; and a blade base engageable with the lower protrusions of the one ore more side walls of the blender base, the blade base including a blade engageable with the electric motor.

A second aspect A2 includes the blender system of any of the previous aspects, where the container is configured to rotatably engage with the blender base in a clockwise direction and the electric motor is configured to rotate in a counterclockwise direction to prevent disengagement between the container and the blender base during operation.

A third aspect A3 includes the blender system of any of the previous aspects, where the container is configured to rotatably engage with the blender base in a counterclockwise direction and the electric motor is configured to rotate in a clockwise direction to prevent disengagement between the container and the blender base during operation.

A fourth aspect A4 includes the blender system of any of the previous aspects, where the electric motor is electrically coupled to the actuator of each switch assembly, where the actuator is selectively actuatable to inhibit the power from being provided from the power source to the electric motor, and where the container is engageable with the actuator of each switch assembly to move the actuator into a lowered position when the container and the blade base are engaged with the blender base.

A fifth aspect A5 includes the blender system of any of the previous aspects, where the blade base further includes an exterior wall, where the exterior wall includes one or more blade notches and the container includes an exterior wall, where the exterior wall includes one or more container notches.

A sixth aspect A6 includes the blender system of any of the previous aspects, where the one or more blade notches are engageable with the one or more container notches to align the container and the blade base.

A seventh aspect A7 includes the blender system of any of the previous aspects, where the container further includes a side wall defining an interior cavity, where the interior cavity includes threads and the blade base further includes an exterior wall, where the exterior wall includes threads engageable with the threads of the container.

An eighth aspect A8 includes the blender system of any of the previous aspects, where each switch assembly of the set of switch assemblies further includes a switch frame defining a hard stop for preventing overextension of the actuator, the actuator is movably mounted on the switch frame, where the actuator includes an actuator plate, where the actuator plate includes a flange and a lower surface, and a switch mounted to the switch from, where the switch includes a trigger that is configured to be engaged by the flange of the actuator.

A ninth aspect A9 includes the blender system of any of the previous aspects, where the lower surface extends outward orthogonally from the actuator plate.

A tenth aspect A10 includes the blender system of any one of the previous aspects, where the flange extends outward in a first direction from the actuator plate and is attached to the lower surface.

An eleventh aspect A11 includes the blender system of any one of the previous aspects, wherein the flange is engageable with the trigger of the switch and the trigger depresses in a direction opposite to the actuator plate and in a direction transverse to a moving direction of the actuator plate.

According to a twelfth aspect A12, a blender system includes a blender base, where the blender base includes an electric motor, a power source including a switch, where the power source is electrically coupled to the electric motor and operation of the switch inhibits power from being delivered from the power source to the electric motor, and a near-field communication (NFC) receiver electrically coupled to the switch of the power source; an adapter engageable with the blender base, where the adapter includes a body having a side wall defining a receptacle, a set of switch assemblies disposed along a periphery of the body adjacent to the side wall, and an NFC transmitter coupled to the set of switching assemblies, where actuation of the set of switch assemblies causes the NFC transmitter to transmit a signal to the NFC receiver of the blender base; a blade base including a blade engageable with the electric motor, the blade base receivable within the receptacle of the body of the adapter; and a container engageable with the blade base, the container including a flange that is engageable with the set of switch assemblies.

A thirteenth aspect A13 includes the blender system of any one of the previous aspects, where the NFC transmitter is configured to detect that the container and the blade base are engaged, power is delivered and the blade base is operable when the container and the blade base are engaged, and power is inhibited and the blade base is inoperable when the container and the blade base are not engaged.

A fourteenth aspect A14 includes the blender system of any one of the previous aspects, where the blender base further includes a blender base body having an exterior wall and a plurality of protrusions, the body of the adapter further defines a recess, and the plurality of protrusions are receivable within the recess of the body of the adapter.

A fifteenth aspect A15 includes the blender system of any one of the previous aspects, where the side walls of the adapter further include an interior surface, where the set of switches are disposed adjacent to the interior surface of the side wall.

A sixteenth aspect A16 includes the blender system of any one of the previous aspects, where the flange of the container further includes a first portion extending outwardly in a first direction from the body of the container and a second portion, where the second portion extends in a second direction that is orthogonal to the first direction.

A seventeenth aspect A17 includes the blender system of any one of the previous aspects, where the container further includes a side wall that defines an interior cavity, where the cavity includes threads and the blade base further includes an upper surface, where the upper surface includes threads engageable with the threads of the container.

According to an eighteenth aspect A18, an adapter engageable with a blade base having an electric motor, a power source, and an NFC receiver, where the adapter includes a body having a side wall defining a receptacle, a set of switch assemblies disposed along a periphery of the body adjacent to the side wall, and an NFC transmitter coupled to the set of switch assemblies, the NFC transmitter communicatively coupled to the NFC receiver of the blender base, and the set of switch assemblies are engageable with a flange of a container that is received within the receptacle.

A nineteenth aspect A19 includes the adapter of any one of the previous aspects, where the body of the adapter further defines a recess, the recess engageable with a plurality of protrusions of the blender base.

A twentieth aspect A20 includes the adapter of any one of the previous aspects, where the side wall of the adapter further includes an interior surface, wherein the set of switches are disposed adjacent to the interior surface of the side wall.

From the above, it is to be appreciated that defined herein is a blender base including a motor, a blender base body including a plurality of upper protrusions, one or more side walls provided on an inner surface of the blender base body, the one or more side walls extending inwardly, the one or more side walls including a plurality of lower protrusions, and a set of switch assemblies, each switch assembly including an actuator extending from an upper ledge of the one or more side walls, the actuators movable between a raised position and a lowered position, a container engaging the upper protrusions of the blender base body of the blender base, and a blade base engaging the lower protrusions of the one or more side walls of the blender base, the blade base including a blade operated by the motor. The container contacts to the actuator of the switch assemblies to move the actuators into the lowered position when the container and the blade base are properly engaged with the blender base. Power is inhibited from being delivered to the motor to operate the blade of the blade base when the actuator of each switch assembly is not in the lowered position.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A blender system, comprising:
a blender base comprising:
an electric motor;
a power source including a switch, the power source electrically coupled to the electric motor, wherein operation of the switch inhibits power from being delivered from the power source to the electric motor;
a blender base body including one or more side walls provided on an inner surface of the blender base body, a plurality of upper protrusions provided on an upper ledge of the one or more side walls, a plurality of lower protrusions extending inwardly from the one or more side walls; and
a set of switch assemblies electrically coupled to the switch of the power source, each switch assembly including an actuator extending through the upper ledge of the one or more side walls, the actuators movable between a raised position and lowered position;
a container engageable with the upper protrusions of the blender base body of the blender base; and
a blade base engageable with the lower protrusions of the one or more side walls of the blender base, the blade base including a blade engageable with the electric motor.

2. The blender system of claim 1, wherein:
the container is configured to rotatably engage with the blender base in a clockwise direction; and
the electric motor is configured to rotate in a counterclockwise direction to prevent disengagement between the container and the blender base during operation.

3. The blender system of claim 1, wherein:
the container is configured to rotatably engage with the blender base in a counterclockwise direction; and
the electric motor is configured to rotate in a clockwise direction to prevent disengagement between the container and the blender base during operation.

4. The blender system of claim 1, wherein:
the electric motor is electrically coupled to the actuator of each switch assembly;
the actuator is selectively actuatable to inhibit power from being provided from the power source to the electric motor; and
the container is engageable with the actuator of each switch assembly to move the actuator into the lowered position when the container and the blade base are engaged with the blender base.

5. The blender system of claim 1, wherein:
the blade base further comprises an outer surface, the outer surface comprises one or more blade notches; and
the container comprises an outer surface, the outer surface comprises one or more container notches.

6. The blender system of claim 5 wherein the one or more blade notches are engageable with the one or more container notches to align the container and the blade base.

7. The blender system of claim 1, wherein:
the container further comprises a side wall defining an interior cavity, the interior cavity comprising threads; and
the blade base further comprises an outer surface, the outer surface comprising threads engageable with the container.

8. The blender system of claim 1, wherein:
each switch assembly of the set of switch assemblies further comprise a switch frame defining a hard stop for preventing overextension of the actuator;
the actuator movably mounted on the switch frame, the actuator comprising an actuator plate, wherein the actuator plate includes a flange and a lower surface; and
a switch mounted to the switch frame, the switch comprising a trigger, the trigger is configured to be engaged by the flange of the actuator.

9. The blender system of claim 8, wherein the lower surface extends outward orthogonally from the actuator plate.

10. The blender system of claim 8, wherein the flange extends outward in a first direction from the actuator plate and is attached to the lower surface.

11. The blender system of claim 8, wherein the flange is engageable with the trigger of the switch and the trigger depresses in a direction opposite to the actuator plate and in a direction transverse to a moving direction of the actuator plate.

12. A blender system, comprising:
a blender base comprising:
an electric motor;
a power source including a switch, the power source electrically coupled to the electric motor, wherein operation of the switch inhibits power from being delivered from the power source to the electric motor; and
a near-field communication (NFC) receiver electrically coupled to the switch of the power source;
an adapter engageable with the blender base, the adapter comprising:
a body having a side wall defining a receptacle;
a set of switch assemblies disposed along a periphery of the body adjacent to the side wall; and
an NFC transmitter coupled to the set of switch assemblies, wherein actuation of the set of switch assemblies causes the NFC transmitter to transmit a signal to the NFC receiver of the blender base;
a blade base including a blade engageable with the electric motor, the blade base receivable within the receptacle of the body of the adapter; and
a container engageable with the blade base, the container comprising a flange that is engageable with the set of switch assemblies.

13. The blender system of claim 12, wherein:
the NFC transmitter is configured to detect that the container and the blade base are engaged;
power is delivered and the blade base is operable when the container and the blade base are engaged; and
power is inhibited and the blade base is inoperable when the container and the blade base are not engaged.

14. The blender system of claim 12, wherein:
the blender base further comprises a blender base body having an exterior wall and a plurality of protrusions;
the body of the adapter further defining a recess; and
the plurality of protrusions are receivable within the recess of the body of the adapter.

15. The blender system of claim 12, wherein the side wall of the adapter further comprises:
an interior surface, wherein the set of switches are disposed adjacent to the interior surface of the side wall.

16. The blender system of claim 12, wherein the flange of the container further comprises:
a first portion extending outwardly in a first direction from the side wall of the container; and
a second portion, wherein the second portion extends in a second direction that is orthogonal to the first direction.

17. The blender system of claim 12, wherein:
the container further comprises a side wall that defines an interior cavity, the interior cavity comprises threads; and
the blade base further comprises an upper surface, wherein the upper surface comprise threads engageable with the threads of the container.

18. An adapter engageable with a blender base having an electric motor, a power source, and an NFC receiver, the adapter comprising:
a body having a side wall defining a receptacle;
a set of switch assemblies disposed along a periphery of the body adjacent to the side wall; and
an NFC transmitter coupled to the set of switch assemblies, the NFC transmitter communicatively coupled to the NFC receiver of the blender base, and the set of switch assemblies engageable with a flange of a container that is received within the receptacle.

19. The adapter of claim 18, wherein the body of the adapter further defines a recess, the recess engageable with a plurality of protrusions of the blender base.

20. The adapter of claim 18, wherein the side wall of the adapter further comprises:
an interior surface, wherein the set of switch assemblies are disposed adjacent to the interior surface of the side wall.
